(19) United States
(12) Patent Application Publication
(10) Pub. No.: US 2006/0120518 A1
(43) Pub. Date: Jun. 8, 2006

(54) Method and system for information relay between multiple user environments

(75) Inventors: Daniel A. Baudino, Lake Worth, FL (US); Deepak P. Ahya, Plantation, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/003,825

(22) Filed: Dec. 3, 2004

(51) Int. Cl. H04M 11/00

(52) U.S. Cl. 379/91.02

(57) ABSTRACT

A system (30) and method (60, 70, 80, and 90) of using a mobile device as an information relay among multiple user environments can include the steps of capturing (76 and 78) a set of application settings and data (or relay data) from a first electronic device during an active session of an application in a first user environment using the mobile device and transferring (87) the set of application settings and data (or relay data) from the mobile device to a second electronic device for continuity of the active session in a second user environment.

### FIELD OF THE INVENTION

This invention relates generally to portability, and more particularly to a method and system for relaying information between different user environments using a mobile device.

### BACKGROUND OF THE INVENTION

Seamless mobility in the contexts of today's electronic devices seem to fail to address beyond content and session handling. A personal digital assistant can synchronize its data among several computers, but each portable device typically fails to account for a user's unique preferences and habits over a different context in terms of time, location, availability of user devices or in terms of the presence of other devices/users, or device capabilities.

A user of a mobile device can be engaged in various different contexts in relation to other devices or in relation to other users (of such devices) within a proximity of the user. Although devices exist that can merely transfer data from one device to another, such devices usually fail to account for a new context or environment in which the user can be set in. Furthermore, such devices typically fail to facilitate the sharing and learning from one fixed user environment to another fixed user environment.

### SUMMARY OF THE INVENTION

Embodiments in accordance with the present invention can provide a means to create an enhanced universal access and experience by learning from users and their interaction with devices in different environments.

In a first embodiment of the present invention, a method of using a mobile device as an information relay among multiple user environments can include the steps of capturing a set of application settings and data from a first electronic device during an active session of an application in a first user environment using the mobile device and transferring the set of application settings and data from the mobile device to a second electronic device for continuity of the active session in a second user environment. The method can further include the steps of detecting the first electronic device with the mobile device and exchanging a profile with the first electronic device. The method can further include the steps of receiving a request to receive relay data from the first electronic device intended for a predetermined device and accepting relay data from the first electronic device. The method can then include the steps of detecting at least the second electronic device as the predetermined device using the mobile device and exchanging a profile with the second electronic device using the mobile device and the steps of sending a request to transfer relay data from the mobile device to the second electronic device and transmitting the relay data to the second electronic device. The set of application settings and data can be information relating to a favorite media type, a favorite website, a user interface preference, a desired interaction style, an environmental preference, an earpiece volume rule, a speaker volume rule, a contact list, user location data, a custom user profile, or a frequently used profile. The set of application settings and data can be a predetermined type of data programmed by the user, or computer data files shared among the first electronic device and the second electronic device, or environmental data used in a user environment for the first electronic device and desired in a user environment for the second electronic device, or personal preference data used at the first electronic device and desired for use at the second electronic device. The set of application settings and data can be predetermined data that is transferred from the first electronic device to the second electronic device, or predetermined data that is useful in all encountered environments, or requested data that reaches a mobile roaming device for return of such requested data, or important data that is transferred to all user devices in all user environments. The method can further include the step of transferring a function performed at the first electronic device to the second electronic device upon the mobile device coming within a proximity of the second electronic device in a substantially seamless manner.

In a second embodiment of the present invention, a system using a mobile device as an information relay among multiple user environments can include a transceiver and a processor coupled to the transceiver in the mobile device. The processor can be programmed to capture a set of application settings and data from a first electronic device during an active session of an application in a first user environment using the mobile device and transfer the set of application settings and data from the mobile device to a second electronic device for continuity of the active session in a second user environment. The processor can be further programmed to detect the first electronic device with the mobile device and exchange a profile with the first electronic device. The processor can be further programmed to receive a request to receive relay data from the first electronic device intended for a predetermined device and accept relay data from the first electronic device. Then, the processor can be further programmed to detect at least the second electronic device as the predetermined device using the mobile device, exchange a profile with the second electronic device using the mobile device, send a request to transfer relay data from the mobile device to the second electronic device and transmit the relay data to the second electronic device. The relay data can include application settings and/or data from the set of application settings and data. The relay data can also include information concerning a favorite media type, a favorite website, a user interface preference, a desired interaction style, an environmental preference, an earpiece volume rule, a speaker volume rule, a contact list, user location data, a custom user profile, or a frequently used profile. The relay data can also include computer data files shared among the first electronic device and the second electronic device, environmental data used in a user environment for the first electronic device and desired in a user environment for the second electronic device, or personal preference data used at the first electronic device and desired for use at the second electronic device. Note, the profile can include user preference data among user content preferences, user habit preferences, user source preferences, and user device feature preferences and wherein the first electronic device and the second electronic device each reside in a stationary or environment. The processor can be further programmed to seamlessly transfer a function performed at the first electronic device to the second electronic device upon the mobile device coming within a proximity of the second electronic device.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a seamless portability system in accordance with an embodiment of the present invention.

FIG. 2 is block diagram of a profile manager that can be used in the seamless portability system of FIG. 1 in accordance with an embodiment of the present invention.

FIG. 3 is a data flow chart illustrating a method of providing seamless portability in accordance with an embodiment of the present invention.

FIG. 4 is a flow chart illustrating a method at a first electronic device of using a mobile device as an information relay among multiple user environments in accordance with an embodiment of the present invention.

FIG. 5 is a flow chart illustrating a method at a mobile device in communication with the first electronic device of receiving relay data in accordance with an embodiment of the present invention.

FIG. 6 is a flow chart illustrating a method at a mobile device in communication with a second electronic device of transmitting relay data in accordance with an embodiment of the present invention.

FIG. is a flow chart illustrating a method at the second electronic device of receiving relay data from the mobile device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments in accordance with the present invention enable a framework for collecting user preferences and habits within each context from multiple electronic devices used by a user. The capabilities of the device (in use) in conjunction with preferences and habit information are used to create enhanced access and experience for the user. Embodiments herein focus on collecting & sharing learning from multiple devices and using this new shared learning to enhance an overall experience on all devices and user surroundings.

The learning at each device can include a myriad of types of information including, but not limited to:
1. Favorite media type (per device or all devices)
2. Favorite websites
3. User Interface preferences
4. Desired Interaction Styles
5. Environment preferences
6. Earpiece/Speaker Distance-Volume Rules
7. Contacts
8. Knowledge of User Personal Data locations (server vs. other devices)
9. User Custom or frequently used profiles

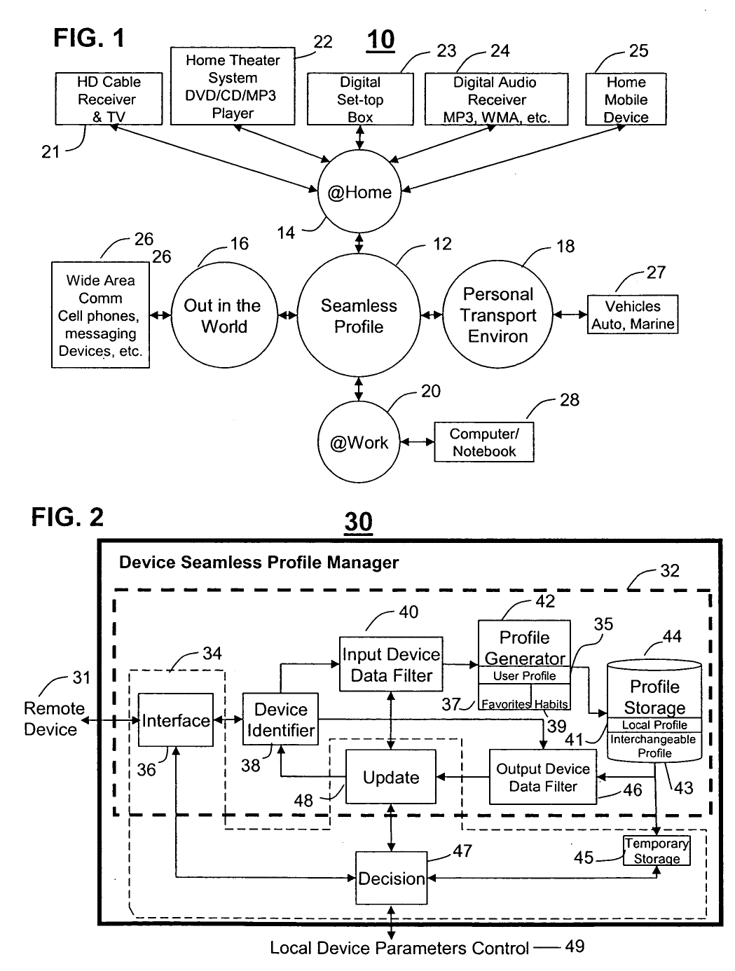

Referring to FIG. 1, a framework 10 is shown that provides “Seamless Learning Portability” among multiple user devices to work together to enhance their respective user interfaces and overall experience among several different contexts or environments. The different environments or contexts can include a home environment 14, a work environment 20, a personal transport environment 18 or an outdoor environment 16. The home environment 14 can include among a high definition (HD) receiver or television 21, a home theater system 22 having DVD or CD or MP3 players or recorders, a digital set-top box 23, a digital audio receiver 24 or a home mobile device 25 such as a remote controller or other similar device. The work environment 20 can include desktop or laptop computers 28, the outdoor environment 16 can include wide area networked communication devices 26 such as cell phones, messaging device or wireless LAN device, and the personal transport environment can include navigation systems, communication, entertainment and telematic devices 27 that might be incorporated in a vehicle. Each device can collect data over time independently from each other. When one device is in proximity of another device, the data can be exchanged between such devices over a wireless LAN or other wireless network. Such data can be stored on each device where each device stores the information that belongs to it and interchanges with other devices when requested. The parameters of the complete profile created based on the user learning can then be exchanged among similar devices creating a seamless learning/profile exchange network 12. As noted examples above, devices providing media content such as TV's, HD cable receivers, digital set-top boxes, home theater systems can contribute to the seamless profile/learning portability aspects herein by collecting and providing a user's favorites/preferences in a list of movies, TV series etc., or a user's habits (volume, network selected, etc), or a user's preferred features (from the device), or a user's taste and watching behaviors, or a profile based on all the information collected from the user. In terms of a home theater system (CD Player, DVD Player, MP3, etc.), such devices that play this type of media can collect a user's favorites or preferences list of songs, radio stations, etc., collect a user's habits (volume, station selected, etc), collect a user's preferred features (from the device), collect user's taste and listening behaviors, or create a profile based on all the information collected from the user. In a computer device such as a desktop or notebook that can also play all types of media (movies, songs, etc) and have the ability to download music, movies, and other data, such a system can collect and track all media played and generate favorites/preferences for media played (songs, movies, etc.), collect user's habits (volume, music web sites used, etc), collect user's preferred media applications, features, media, media web sites, etc., or create profiles of user's taste and listening/watching behaviors. In a vehicle such as an automotive environment, a profile and user habits can be tracked, created and stored by collecting information regarding the stations or artists listened to on a radio or CD, configurations for car temperature, seat positions, and other settings encountered in an automotive environment. With handheld devices (mobile phones, Wireless IM, PDA, etc), such devices can store and collect information related to media, UI, location, chat buddies, or other information in forming a profile based on the user behavior. Similarly, a security system or home monitoring system can control and track temperature, alarm settings and other user information that can also be used to form a profile to enhance a users experience.

Referring to FIG. 2, a high-level architecture diagram of the profile manager 30 is shown that can reside on each type of device in the framework 10 (see FIG. 1). The profile manager 30 can include a first area 32 that can include all the profile generation/interchange architecture and a second area 34 used for requesting control of the parameters of the (local) device based on the profile/information received.

The first area 32 can include a interface module 36 that abstracts all types of short range communications (Bluetooth, WLAN, Zigbee™ or IEEE 802.15.4, etc) to the rest of the profile manager, a device identifier 38 that identifies a remote device 31 and identifies the data that can be shared (not necessarily between just the local device and the remote device, but amongst many or all devices in the framework 10). The first area 32 can further include an input device data filter 40 that filters and sends appropriate information (filtered to match the local device) to a profile generator 42. The profile generator 42 creates a user profile 35, habits (list) 39, favorites (list) 37, and other information that can be used in a profile. The first area 32 can also include an output device filter 46 that sends appropriate information (filtered to match the local device) to a Update module 48. The Update module 48 detects what needs to be updated (what is new to be updated on the remote device). Coupled between the profile generator 42 and the output device filter 46 and included in the first area 32 is a profile storage 44 having for a local profile 41 and an interchangeable profile 43.

The second area 34 also includes and shares with the first area 32 the interface module 36 and the Update module 48. The update module 48 in this regard can be used in controlling both the local (or local device parameter controls 49) and remote device 31 in conjunction with a decision module 47. For example, the update module 48 can update a temperature reading from the remote device 31 to the local device (or another remote device). The decision module 47 indicates to remote device 31 and/or local device to take action (i.e., change volume settings, change temperature settings, etc.). The second area 34 can further include a temporary storage 45 that stores only the data interchanged and generally not data that is part of the profile (latest temperature readings, etc). The data in the temporary storage 45 generally expires (particularly if the local device did not find any other remote device that takes the temperature for example).

Below are examples of tables and information that can be used in an individual user's profile or a group user profile:

Information Collected:

| Attribute | Description |
|---|---|
| Entry ID | Event ID |
| Type | Type associated to the entry (type of media, email, etc) |
| Action | Action performed on the type entry (play, record, edit, |
| | read, write) |
| Location | Coordinates from which the action was executed. |
| Time and Date | Time and date from which the action was executed. |
| Duration/status | Length of the event, played/recorded in full, etc. |

With the collection of above, the following information can be classified:

Entertainment Favorites:

| Attribute | Description | | | |
|---|---|---|---|---|
| Type | Media (Movie, songs), UI (shortcuts) | | | |
| Source | Media source: Cable, Satellite, CD, Downloaded (URL | | | |
| | of the dire is stores separately), etc. | | | |
| Genre | Media genre. | | | |
| Location | Coordinates of the favorite list | | | |
| Time and Date | Time and Date of the creation | | | |
| Last entry | Time and Date of the last entry | | | |
| List Items | Entries on the favorite lists | | | |
| User Profile | Type | Music, Movies, etc | Profile | Like, Dislike, |
| | | | | taste, etc. |

User's Habits:

| Attribute | Description | | | |
|---|---|---|---|---|
| Environment | Volume, temperature | | | |
| Preferences | | | | |
| Location | Habit Coordinates | | | |
| User Profile | Type | Media, UI, | Profile | Like/dislike/Genre |
| | | etc. | | associated with the type |
| | | | | most used items, time of |
| | | | | the most used items, etc |

User Interface:

| Attribute | Description | | | |
|---|---|---|---|---|
| Feature | Applications used, frequency, etc | | | |
| Preference | | | | |
| Learning | History, UI usage. | | | |
| Profile | | | | |
| Location | Habit Coordinates | | | |
| User Profile | Type | Media, UI, | Profile | Like/dislike/Genre |
| | | etc. | | associated with the type |
| | | | | most used items, time of |
| | | | | the most used items, etc |

From the learning in the form of collected data in tables as illustrated above, user profiles corresponding to location and time, interaction sensitive profiles are created. The information collected, the profile generated as well as favorite lists can be interchanged upon device request.

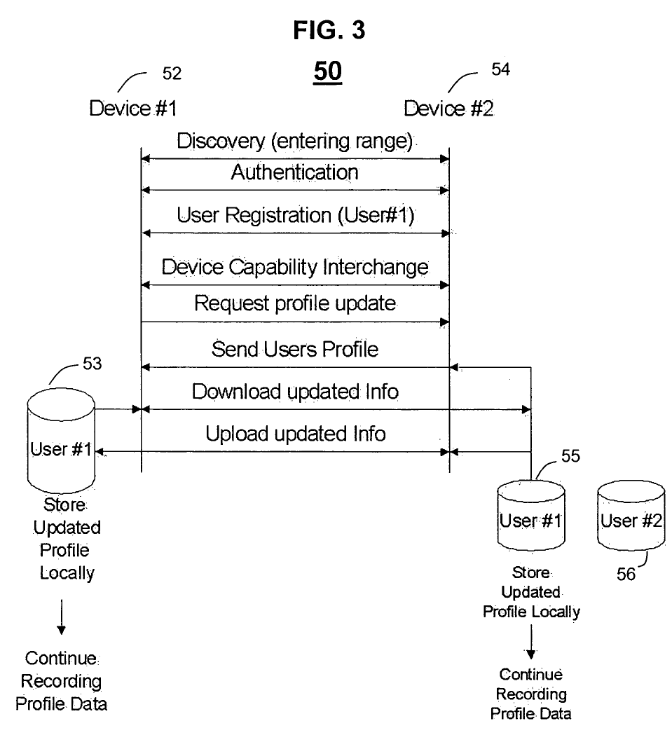

The manner in which information or profiles are interchanged is further illustrated with reference to the data flow diagram 50 of FIG. 3. The interchange can take the form of a peer to peer device profile interchange among a first device 52 having a first user profile 53 and a second device 54 having a first user profile 55 as well as an optional second user profile 56. In general, the first and second devices can be fixed or mobile. More specifically, once the devices are within a predetermined proximity or range (using Bluetooth, WLAN, Zigbee™ or IEEE 802.15.4, etc) of each other, they are in discovery and can start interchanging information. Both devices can authenticate by interchanging the device certificates for example. After a successful authentication, the user can register since it can be a multiple user device (as illustrated with the two user profiles for the second device 54). The registration can be done automatically without user intervention. After successful registration, the devices (52 and 54) can interchange their capabilities and settings (device type, data type accepted for the device, profile type) information. The capabilities interchange is particularly useful for both devices in determining what type of profile/data to interchange. In one embodiment, once all the data is interchanged, one of the devices (in this example, device 52) takes master ownership and requests a profile from the other device 54 (time stamped profile/parameters). Once the master device (52) gets the information (parameters/profiles), the device 52 can generate difference from what is stored locally and send it to the other device 54. After all the data is downloaded successfully, the master device 52 starts sending its own profile to the other device. Once all the data is updated, then both devices can start using the new parameters/profile and can update the respective User interfaces, favorites, etc. on each of the devices.

A mobile handheld device is typically the only device that moves around with the user. The mobile device is usually the only device that comes in contact with all the user environments and devices in those environments. The fixed user devices (e.g., air conditioning or heating systems, home stereo systems, etc.) in fixed user environments can have common information to share but will never get the opportunity to share such information. The mobile device can also be used to relay information for user devices that are never in contact with each other but can benefit from knowledge or information gathered in different environments. The mobile device can transfer profiles/learning parameters about a user and a user's preferences or habits or other user related information from user devices in one user environment to user devices in another user environment. One user environment can include the mobile device as part of a first set of devices while another user environment can include the mobile device as part of yet another set of devices. Note, the profile/learning parameters carried by the mobile device does not necessarily need to be useful or even usable by the mobile device itself, yet it can carry and pass on such information between other user devices.

The information can be transferred among electronic devices by a mobile device in quite a different number of ways. In one case, a certain type of information or pre-programmed information can be transferred as designated by a user. For example, if a user wants to carry a certain type of information with him or her every time that he or she goes from their house to their office such as computer files from an office to a home computer, then such information can automatically be transferred during such transitions. In another case, there can be information that is very useful across all environments that a user may want to always transfer. For example, the temperature settings from a car or an office can be carried to the home using the mobile device. In another case, specific information can be requested. Devices that are not mobile or within reach can request from a mobile (or roaming) device to find out about certain information. For example, a computer at an office can request certain information from a mobile device in its range. The mobile device can go and look for the information requested every time that another device is in range of the mobile device. When the mobile device is in range with another device, it will request the information and store it for later delivery to the requester.

In yet another case, there can be instances where information that is considered important from user's point of view that should be known be all user devices in all user environments. For example, if a person has an illness or has been sick for a few days, the devices in a home environment has learned to assist the user with coping up with the illness. Once the user is ready to return to work, the information related to the user's illness can be saved in the mobile device to enable the mobile device to inform all user devices in all user environments (including shared user device) about the user's condition and preferences. When the user gets to the office, the mobile device can inform several user devices about the user condition. In response, for example, the office computer can try to keep the schedule light (inform other users to restrain from setting up too many meetings or at least warn them) and send reminders to the user to drink sufficient fluid and the ventilation system in the user's office can adjust the temperature and humidity to a comfortable level ideal for recovery from such illness.

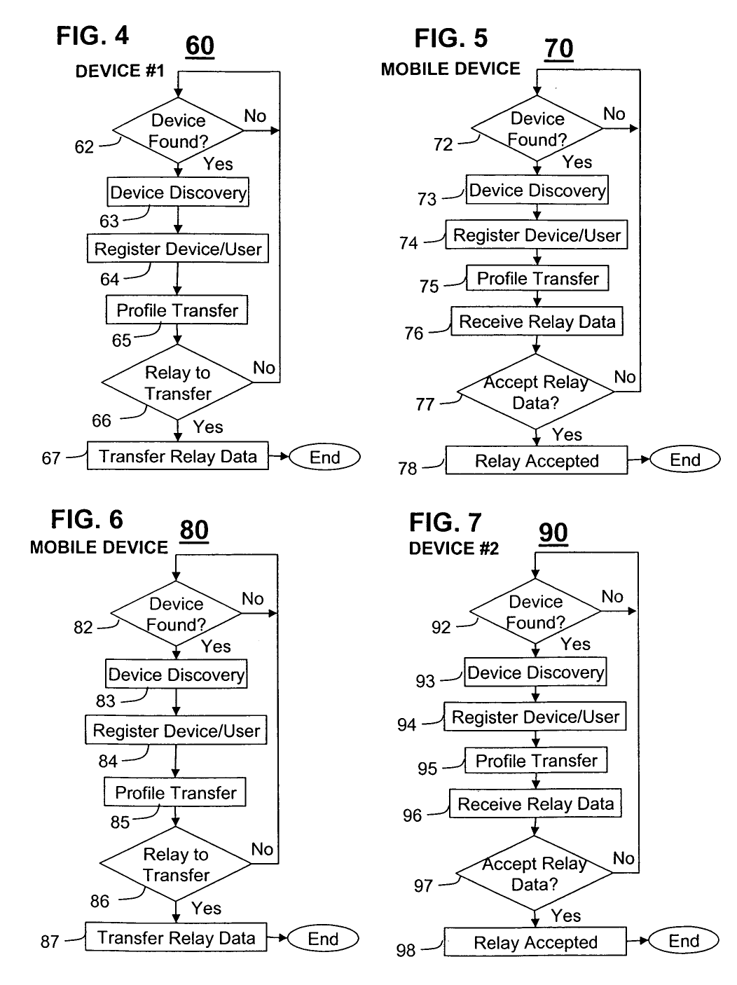

In one embodiment though as illustrated in FIGS. 4-7, flow charts illustrating how a mobile device can learn from a first device (Device #1) in one environment and transfer such learning to a second device (Device #2) in a different environment. Referring to FIGS. 4, 5, 6 and 7, methods 60, 70, 80 and 90 illustrate such an interchange among a first and a mobile device and subsequently among the mobile device and the second device. In method 60 at Device #1, if another device such as the mobile device is discovered at decision block 62, then device discovery 63, registration 64, and profile transfer 65 can proceed as previously described above with regard to FIG. 3. At decision block 66, if relay data is ready to transfer, then relay data such as temperature, volume, files, settings, preferences, etc. is transferred at step 67 in a media session for example. If no device is found at decision block 62 or if no relay data needs transferring at decision block 66, then the method continues to poll for other devices at decision block 62. Similarly at the mobile device, the method 70 determines if another device is discovered at decision block 72, then device discovery 73, registration 74, and profile transfer 75 proceeds as previously described above and the relay data is received at step 76. At decision block 77, a determination is made whether the relay data will be accepted. If the relay data is accepted at decision block 77, then the mobile device can be configured to store the relay data and serve as a relaying device. Note, the relay data does not necessarily need to be useful for the mobile device since the mobile device can be used as a mere conduit for transferring a set of applications settings and data (relay data) to a second electronic device (Device #2). For example, a mobile device such as a phone can be used to relay temperature settings from a home environment to an automobile or office environment. In such a scenario, the phone itself does not necessarily use the temperature settings information to adjust functions at the phone (the mobile device). In other instances, the relay data can be used by the mobile device as well. For example, if the mobile device is an MP3 player (with a Bluetooth connection for example), a song played at a fixed home entertainment system having an MP3 player can transfer the relay data (e.g., the song and the last position before a session transfer) and play the song on the mobile device for a period before another session transfer occurs to another environment such as a car stereo (MP3) system.

Referring to FIG. 6, once the mobile device has the relay data, a determination is made whether another device is found at decision block 82. If another device such as Device #2 is discovered at decision block 82, then device discovery 83, registration 84, and profile transfer 85 can proceed as previously described. Then, at decision block 86, if relay data is ready to transfer, then relay data such as temperature, volume, files, settings, preferences, etc. (obtained from Device #1) is transferred to Device #2 at step 87 in a media session for example. If no device is found at decision block 82 or if no relay data needs transferring at decision block 86, then the method continues to poll for other devices at decision block 82. Note, a transfer of relay data can also involve a transfer of an application session from one device to another. Examples of application sessions that can be transferred can include transferring of desktop sessions, MP3 player sessions, video player sessions, email sessions, and business application sessions generally to name a few. In the case of a desktop session transfer, the user's look and feel (such as wallpaper, ring tones, background clock features and the like can transfer from one device to the next if applicable and desired).

Similarly at Device #2, the method 90 determines if the mobile device is discovered at decision block 92, then device discovery 93, registration 94, and profile transfer 95 proceeds as previously described above. Then, the relay data can be received at step 96 whereupon a determination is made whether the relay data is acceptable at decision block 97. If the relay data is acceptable at decision block 97, then such relay data can be implemented or utilized at Device #2 at step 98. Device #2 can now has settings/preferences from Device #1 (and optionally the mobile device) and will operate accordingly (in accordance with relay data that can be set or utilized at Device #2). If there is no device found at decision block 92 or if there is no relay data to transfer at decision block 97, then the method 90 continues to poll for devices at decision block 92.

Note, the profile interchange can also take place in many different ways. In a one to one interchange, it should be noted that certain devices have multiple owners or users (TVs, set-top boxes, etc.). In such instance, then the authentication can be created for each user to enable a data interchange only when the user of the user device is present (the user must do a manual configuration on the TV before using this feature, unless the TV can automatically discover the particular user from the user device). For example, a user leaves home wearing his or her cell phone and gets into their car. The car updates all the profile, tunes the radio to the same radio station as the user was listening on the radio (either on the cell phone or on a home entertainment system), or sets up the music based on the user profile. Before leaving the house, all the devices setup the recording times for the most watched TV networks on a recording device (DVR/VCR).

In a conditional interchange, data can be interchanged as requested. For example, in an interchange profile between husband and wife profile, upon the husband and wife coming within proximity of each other, they can share the profile information stored on both handheld devices if either the husband or wife requested it. The interchange can require a manual authentication from both sides.

In a manual interchange, the user must give his/her feedback to the device before interchanging profile data. For example, when a user buys a new phone, all the information can be transferred from one phone to another where the transfer is requested manually.

There are also instances where interchange with an other device is not possible. The interchange also can be setup to be one way only. In one example, a user rents a car and once he or she gets in, the car updates the profile based on the information carried by the user, but it does not share the cars profile with the user. In another example, a user visiting their child desires to watch all their favorites sporting events. A set top box at their child's house can download all the user's profile without necessarily storing it. The child's profile (from the set-top box or from other devices at the child's home) does not necessarily get downloaded to the user's (visiting parent's) handheld device.

In a more tailored fashion, a profile can be set up so the user can control what particular information can be shared as well as what to share according to the device or user in a profile level interchange. In one example, a husband and wife coming within proximity with each other can share profile information marked as “interchangeable” on both devices.

In an open interchange, a device will not require ownership; but will accept all profiles. In an open interchange scenario, there are several levels of open authentication. In a first case, the subject device will receive all device profiles, but will not interchange the learned capabilities with other devices (e.g., handheld device approaching a rental car). For example, when a user rents a car and once he or she gets in, the car updates the profile based on the information carried by the user, but it does not share the car's profile with the user. In a second case, the subject device will receive all device profiles, but will only interchange the learned capabilities since the last time that the particular owner of the subject device registered (e.g., the user travels to the same location and wants to learn the radio stations so next time that user travels to the same location all the information can be retrieved again with minimal or no user interaction). In a third case of an open interchange, there can be a limited interchange when a user gets in range, (e.g., when the user goes to visit relatives and logs into a set top box, the user might want to share his or her profile with respect to information useful for the set top box only). For example, a user visiting his daughter and desiring to watch the all his favorite sporting events can have a set top box at his daughter's house download his profile without necessarily storing it while his daughter's profile does not get downloaded to his handheld device.

In yet another example illustrating the seamless portability aspects herein, a user using an MP3 player on a mobile device can have a play list selected and activated in a session on the mobile device. When the mobile device comes within range of a different device (e.g., a home entertainment system) that can take a similar session, then the profile is interchanged (immediate data can be interchanged with the profile). The profile is stored on the second device and the immediate data is acted upon at the new or different (or second) device. The second device takes the play list (immediate data) and selects this list and starts playing the play list or the particular song that was playing on the mobile device (e.g., by searching on a CD database at the home entertainment system and selecting the songs included on the play list). The immediacy data transfer is processed with or without local device storage. It is used to transfer the information related to the session that the user is involved on (Multimedia session—play list, songs playing, etc) to keep the experience going and hopefully seamless in most embodiments. The seamless profile portability helps a user to take the same radio station, media favorites, music or other desired characteristic when going from home to the car and to the office or among other environments. Using this method, the user devices can use a diverse set of user devices and environments for building user profiles overtime. Thereby, each user device becomes capable of providing an enhanced interface and experience in different contexts by carrying user related information (and other information) collected by user devices in one environment to other user devices in other environments with a sense of continuity.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of using a mobile device as an information relay among multiple user environments, comprising the steps of:
capturing a set of application settings and data from a first electronic device during an active session of an application in a first user environment using the mobile device; and
transferring the set of application settings and data from the mobile device to a second electronic device for continuity of the active session in a second user environment.

2. The method of claim 1, wherein the method further comprises the steps of detecting the first electronic device with the mobile device and exchanging a profile with the first electronic device.

3. The method of claim 2, wherein the method further comprises the steps of receiving a request to receive relay data from the first electronic device intended for a predetermined device and accepting relay data from the first electronic device.

4. The method of claim 3, wherein the method further comprises the steps of detecting at least the second electronic device as the predetermined device using the mobile device and exchanging a profile with the second electronic device using the mobile device.

5. The method of claim 4, wherein the method further comprises the step of sending a request to transfer relay data from the mobile device to the second electronic device and transmitting the relay data to the second electronic device.

6. The method of claim 1, wherein the set of application settings and data comprises information concerning at least one among a favorite media type, a favorite website, a user interface preference, a desired interaction style, an environmental preference, an earpiece volume rule, a speaker volume rule, a contact list, user location data, a custom user profile, and a frequently used profile.

7. The method of claim 1, wherein the set of application settings and data is a predetermined type of data programmed by the user.

8. The method of claim 1, wherein the set of application settings and data comprises at least one among computer data files shared among the first electronic device and the second electronic device, environmental data used in a user environment for the first electronic device and desired in a user environment for the second electronic device, and personal preference data used at the first electronic device and desired for use at the second electronic device.

9. The method of claim 1, wherein the method further comprises the step of a substantially seamless transfer of a function or an application session performed at the first electronic device to the second electronic device upon the mobile device coming within a proximity of the second electronic device.

10. The method of claim 1, wherein the set of application settings and data comprises one among predetermined data that is transferred from the first electronic device to the second electronic device, predetermined data that is useful in all encountered environments, requested data that reaches a mobile roaming device for return of such requested data, and important data that is transferred to all user devices in all user environments.

11. A system using a mobile device as an information relay among multiple user environments, comprising:
a transceiver; and
a processor coupled to the transceiver in the mobile device, wherein the processor is programmed to:
capture a set of application settings and data from a first electronic device during an active session of an application in a first user environment using the mobile device; and
transfer the set of application settings and data from the mobile device to a second electronic device for continuity of the active session in a second user environment.

12. The system of claim 11, wherein the processor is further programmed to detect the first electronic device with the mobile device and exchange a profile with the first electronic device.

13. The system of claim 12, wherein the processor is further programmed to receive a request to receive relay data from the first electronic device intended for a predetermined device and accept relay data from the first electronic device.

14. The system of claim 13, wherein the processor is further programmed to detect at least the second electronic device as the predetermined device using the mobile device and exchange a profile with the second electronic device using the mobile device.

15. The system of claim 14, wherein the processor is further programmed to send a request to transfer relay data from the mobile device to the second electronic device and transmit the relay data to the second electronic device.

16. The system of claim 11, wherein the relay data comprises information concerning at least one among a favorite media type, a favorite website, a user interface preference, a desired interaction style, an environmental preference, an earpiece volume rule, a speaker volume rule, a contact list, user location data, a custom user profile, and a frequently used profile.

17. The system of claim 11, wherein the relay data comprises at least one among computer data files shared among the first electronic device and the second electronic device, environmental data used in a user environment for the first electronic device and desired in a user environment for the second electronic device, and personal preference data used at the first electronic device and desired for use at the second electronic device.

18. The system of claim 11, wherein the processor is further programmed to seamlessly transfer a function or an application session performed at the first electronic device to the second electronic device upon the mobile device coming within a proximity of the second electronic device.

19. The system of claim 11, wherein the profile comprises user preference data among user content preferences, user habit preferences, user source preferences, and user device feature preferences and wherein the first electronic device and the second electronic device each reside in a stationary or environment.

20. A machine readable storage, having stored thereon a computer program having a plurality of code sections executable by a machine for causing the machine to perform the steps of:
capturing a set of application settings and data from a first electronic device during an active session of an application in a first user environment using the machine; and
transferring the set of application settings and data from the machine to a second electronic device for continuity of the active session in a second user environment.
